(19) United States
(12) Patent Application Publication
(10) Pub. No.: US 2003/0180442 A1
(43) Pub. Date: Sep. 25, 2003

(54) Vehicle component paint matching system

(76) Inventor: Charles B. Hopson, Lebanon, TN (US)

Correspondence Address: CARLSON, GASKEY & OLDS, P.C., 400 WEST MAPLE ROAD, SUITE 350, BIRMINGHAM, MI, 48009, US

(21) Appl. No.: 10/103,063

(22) Filed: Mar. 21, 2002

(51) Int. Cl. B05D 1/00

(52) U.S. Cl. 427/8; 118/668

(57) ABSTRACT

A system of ensuring that various portions of a vehicle exterior have matching color paint monitors the color applied to a first portion of the vehicle at a first paint application station. A sensor provides information regarding a paint color being applied to a second portion of the vehicle. A controller that includes data regarding the paint applied to the first portion of the vehicle preferably adjusts, as necessary, the color of paint being applied to the second portion of the vehicle so that the colors on the vehicle portions match. In one example, a marking device is utilized to provide an indication of an association between a particular first portion of the vehicle and a matching colored second portion of the vehicle so that correspondingly colored portions can be assembled at a final assembly location.

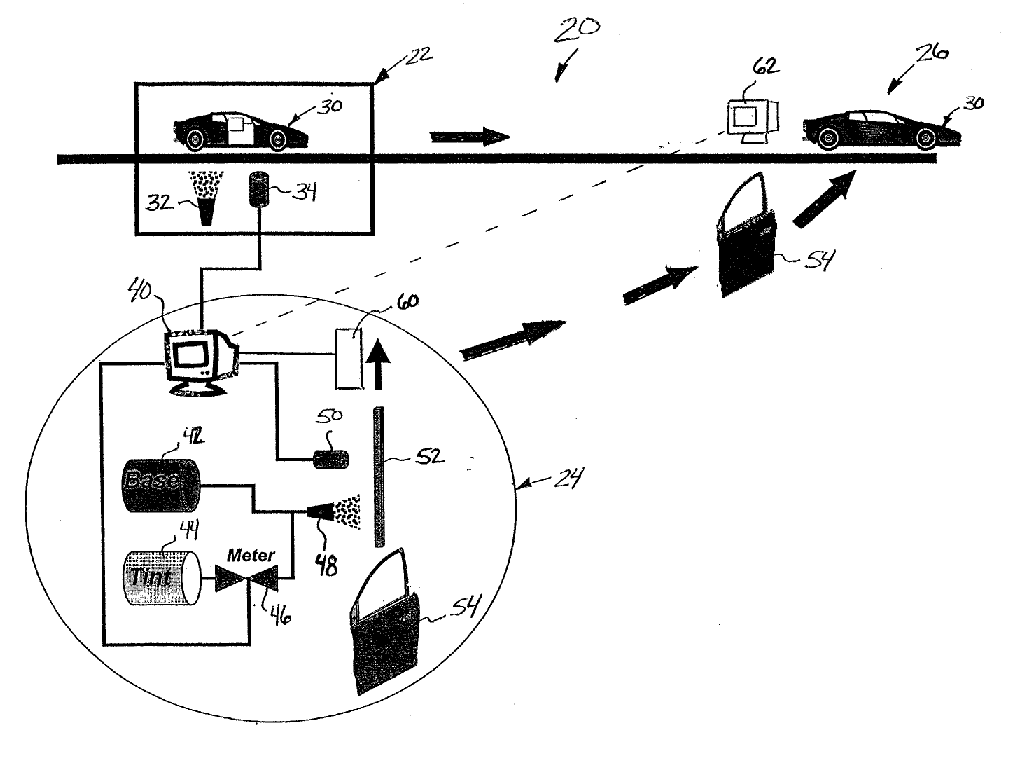

### BACKGROUND OF THE INVENTION

This invention generally relates to a system for ensuring that paint colors on various vehicle exterior components match even when they are painted using different paint application equipment.

One of the recent trends in vehicle manufacturing is to prefabricate modules or portions of the vehicle at a separate location from the main vehicle assembly line. A variety of efficiencies are realized by preassembling door modules or roof modules, for example. In the case of door modules, the various components that are supported on the door, such as audio system speakers, windows raiser units and locks can often be more conveniently and more economically situated on the door in a location separate from the main vehicle assembly line.

Because assembling separate vehicle modules or portions provides such economies, they are an attractive option. One difficulty associated with utilizing that option, however, is ensuring that the color of the vehicle module is consistent with the remainder of the vehicle upon completing assembly. One particular challenge is ensuring that there is an exact color match in paint applied to an exterior surface of a door module and paint applied to the remainder of the vehicle body when the module is painted at a separate location from the remainder of the vehicle body.

The possibility exists for minor variations in paint color, depending on conditions at a paint application station or the performance of particular paint application equipment, for example. Even minor variations in color are visually apparent and render a door module that does not exactly match unusable with the particular vehicle body. In situations where there may be variations over time, it can be appreciated that the additional expenses of repainting or otherwise handling mismatching modules or components can become quite expensive.

There is a need for a system that ensures appropriate color matching on such modules and vehicle body components. This invention provides such an arrangement.

### SUMMARY OF THE INVENTION

In general terms, this invention is a system for ensuring that the paint color of a vehicle body matches a paint color on a module or portion of the vehicle that is painted separate from the rest of the vehicle.

A system designed according to this invention includes a first sensor that provides an indication of a color of paint applied to a first portion of the vehicle at a first paint application station. A controller communicates with the first sensor and determines the color of paint applied to the first portion of the vehicle. A second sensor provides an indication of a color of paint being applied at a second application station. The controller controls a paint color adjuster at the second application station. The controller gathers information from the second sensor and causes the paint color adjuster to adjust the color of paint at the second application station, when necessary, to match the color applied to the first portion of the vehicle at the first application station.

In one example, the controller provides an association between the first and second vehicle portions having matching paint colors to facilitate later assembly of the first and second portions. The association between the first and second portions of the vehicle may be based upon a vehicle identification number or a lot number of a plurality of vehicle portions that are painted in one of the paint application stations, for example.

A method of applying matching paint to separate portions of a vehicle performed according to this invention includes several steps. A color of paint applied to a first vehicle portion is determined. The color of paint applied at a second application station is monitored and adjusted as needed so that the color of paint at the second application station matches the color of paint applied to the first vehicle portion. The matching color of paint is then applied to the second vehicle portion so that the colors of the separate portions of the vehicle match.

The various features and advantages of this invention will become apparent to those skilled in the art from the following detailed description of the currently preferred embodiment. The drawing that accompanies the detailed description can be briefly described as follows.

### BRIEF DESCRIPTION OF THE DRAWINGS

The FIGURE schematically illustrates a system designed according to this invention for ensuring that various painted portions of a vehicle match.

### DETAILED DESCRIPTION OF THE PREFERRED EMBODIMENT

A paint matching system 20 facilitates ensuring that paint applied to a first portion of a vehicle at a first paint application station 22 matches the color of paint applied to a second portion of the same vehicle at another paint application station 24. The paint application stations 22 and 24 may be geographically remote from each other, depending on the needs of a particular situation. The paint application stations may be within the same building although set up to address the particular needs of painting specific portions of the vehicle. It is also within the scope of this invention for the two schematically illustrated paint application stations 22 and 24 to be the same physical location and to include the same equipment but to be used at different times to apply paint to the different vehicle portions. The phrase “paint application station” should be understood as including any of those possibilities, among others.

With this invention, matching vehicle portions are provided at a final assembly location 26 so that the various portions of the vehicle 30 all have the same painted color.

The first paint application station 22 includes paint application equipment 32 and a first sensor 34. A controller 40 communicates with the first sensor 34 to determine as closely as possible the exact color of paint applied to the portion of the vehicle 30 within the paint application station 22. Variations in the performance of the paint application equipment 32 or variations in the content of the paint used at that station, for example, may cause slight variations in the tint of the paint color. The sensor 34 gathers enough information for the controller 40 to make a determination of the exact color applied to the first portion of the vehicle 30.

The controller 40 controls a mixture of paint applied at the second station 24 from a base supply 42 and a tint supply 44 by controlling a metering device 46. Such metering devices and strategies for controlling them to achieve a desired color mixture are known.

The color of paint applied using paint application equipment 48 preferably is monitored by the controller 40 by communicating with a color sensor 50. In the illustrated example, the paint application equipment 48 applies paint to a test part 52 that is monitored by the sensor 50. The controller 40 determines whether the color of the test part appropriately matches the color of paint applied to the first portion of the vehicle 30 at the first application station 22. The controller 40 preferably makes adjustments to the color of paint applied by the application equipment 48 as needed before painting a second portion of the vehicle 54. The illustrated example includes a door module 54 as the second portion of the vehicle. The sensor 50 preferably monitors the color of the door module 54 so that the controller 40 may verify that an appropriate paint match has been achieved.

The illustrated example includes a marking device 60 that provides an identifier onto the door module 54 to associate the door module 54 with the vehicle 30, which has a matching color paint. In one example, the marking device 60 is automated and controlled by the controller 40. In another example, the marking device 60 is partially automated in that it receives information for assigning an identifier from the controller 40 while it requires some manual application of a label, for example, to a particular vehicle portion so that the appropriate association may be made at the assembly line 26.

The association made between a first portion of the vehicle and the second portion of the vehicle may be based upon the vehicle identification number, for example. This particular approach may be useful where a relatively small number of vehicles are manufactured by a particular facility, such as specialty vehicles. In another example, when the performance of the paint application equipment 32 is consistent enough over an entire vehicle lot, a lot number can be assigned to a particular set of vehicles and an associated set of door modules and that association can be appropriately placed onto the door modules using the marking device 60 so that the proper door modules can be coordinated with the proper vehicles at the assembly line 26.

The illustrated example includes a data processing module 62 that receives information from the controller 40 to facilitate associating the appropriately colored door modules with the remaining portions of vehicles. There are a variety of strategies for insuring that matching colored components end up on the same vehicle and those skilled in the art who have the benefit of this description will be able to choose an appropriate association strategy to meet the needs of their particular situation.

The various components schematically illustrated in this FIGURE, such as the paint application equipment and the sensors, can be realized using known, commercially available components. Those skilled in the art who have the benefit of this description will be able to suitably program a controller 40, which may be a computer or microprocessor, to achieve the results provided by this invention.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

I claim:

1. A system for painting various portions of a vehicle exterior, comprising:
a first sensor that provides an indication of a color of paint applied to a first portion of the vehicle in a first paint application station;
a controller that communicates with the first sensor and determines the color of paint applied to the first portion;
a second sensor that provides an indication of a color of paint being applied at a second application station; and
a paint color adjuster at the second application station, the controller communicating with the second sensor and selectively causing the paint color adjuster to adjust the color of paint at the second application station such that the color applied to a second portion of the vehicle at the second station matches the color applied to the first portion of the vehicle.

2. The system of claim 1, wherein the controller provides an association between the first and second vehicle portions having matching paint colors.

3. The system of claim 2, wherein the association comprises a vehicle identification number and a second portion number.

4. The system of claim 2, wherein the association comprises a lot number for each of the first and second vehicle portions.

5. The system of claim 2, including a marking device that marks the second vehicle portion with an identifier that associates the second portion with a matching colored first vehicle portion.

6. The system of claim 1, wherein the second paint application station includes a paint application device having a supply of base and a supply of tint and a metering device that adjust an amount of the tint and the base responsive to the controller.

7. A method of applying matching paint to separate portions of a vehicle, comprising the steps of;
determining a color of paint applied to a first vehicle portion at a first paint application station;
monitoring a color of paint applied at a second paint application station;
adjusting the color of paint applied at the second paint application station when the color at the second station does not match the color applied to the first vehicle portion; and
applying a color of paint to a second vehicle portion at the second paint application station that matches the color applied to the first vehicle portion.

8. The method of claim 7, including applying paint at the second paint application station to a test part and determining a color of the paint by observing the test part.

9. The method of claim 8, including using an optical sensor to observe the test part.

10. The method of claim 7, including identifying first and second vehicle portions having a matching color.

11. The method of claim 10, including assigning an identifier to the second vehicle portion that correlates the second vehicle portion to a matching colored first vehicle portion.

12. The method of claim 11, including relating the second vehicle portion identifier to a lot identifier of a plurality of first vehicle portions having a matching color.

13. The method of claim 11, including relating the second vehicle portion identifier to a vehicle identification number associated with the first vehicle portion.
